(19) United States
(12) Patent Application Publication
(10) Pub. No.: US 2009/0005141 A1
(43) Pub. Date: Jan. 1, 2009

(54) Personalized Multiplayer Media Game or Quiz

(75) Inventors: Arto Lehtiniemi, Lempaala (FI); Antti Eronen, Tampere (FI); Jukka Holm, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/780,989

(22) Filed: Jul. 20, 2007

Related U.S. Application Data
(60) Provisional application No. 60/934,926, filed on Jun. 26, 2007.

(51) Int. Cl. A63F 9/24; A63F 13/02; A63F 13/12

(52) U.S. Cl. 463/9; 463/31; 463/42

(57) ABSTRACT

A method, apparatus, computer program product and system are provided for providing a multiplayer media trivia quiz or game that generates and provides personalized questions on the fly. In particular, each time a new quiz or game commences, the media files (e.g., music, video, etc.) stored on each of the players' electronic devices may be analyzed in order to find out in which music, videos, and the like, each of the players is interested and/or has knowledge. This information may then be used to generate trivia questions that are more specific to the people playing the game at that moment. The information may be gathered and new questions may be generated each time a player commences a new game, thus taking into consideration changes in the players' tastes and media collections, as well as preventing the players from learning and possibly memorizing the questions provided.

### CROSS-REFERENCE TO RELATED APPLICATIONS

This application claims the benefit of U.S. Provisional Application No. 60/______, filed Jun. 26, 2007, entitled “Personalized Multiplayer Media Game Or Quiz” which is hereby incorporated herein in its entirety by reference.

### FIELD

Exemplary embodiments of the invention relate, generally, to multiplayer gaming and, in particular, to personalized multiplayer media trivia.

### BACKGROUND

The use of electronic devices, such as cellular telephones, personal digital assistants (PDAs), laptops, personal computer (PCs), and the like, to play games has become extremely popular. In fact, many electronic games now exist that allow people who are located remotely from one another to play against each other over a communication network, such as the Internet. One popular type of game is a music, video/movie, or other media content, trivia game. An example of such a game is Buzz!™: The Music Quiz, created for the Sony PlayStation® 2 or PS2′. Buzz!™ provides players with one of over 1000 music clips and over 5000 questions and allows the players to pretend like they are actual contestants in a quiz show complete with buzzers, theme songs and canned audience applause and laughing. Sony PlayStation also provides the EyeToy for use in playing Buzz!™ and other games. The EyeToy is a color digital camera, similar to a webcam, that uses computer vision to process images taken by the camera. This allows players to interact with games using motion, color detection, as well as sound using a built-in microphone.

A problem with most of the media trivia games or quizzes available, however, is that the quality of the questions asked can vary considerably. The pool of media from which the questions can be pulled is extremely voluminous when one considers music, movies, still images and other forms of entertainment dating as far back as the 1920's to today. As a result, while some of the questions included in the quiz or game may be appropriate for the majority of players, many will not. This is compounded by the fact that individuals' tastes can vary considerably, providing them with a familiarity with one type of music or video, but no knowledge whatsoever regarding the other numerous types. This may cause the players to know the answers to very few of the questions posed, which is likely much less enjoyable. In addition, if players play a game or quiz on a regular basis, it is likely that they will be able to learn and even memorize the questions and, therefore, the answers, to the limited number of questions provided, making extended and repeated gameplay less enjoyable.

One solution to the above problem with many music or other media quizzes and games is provided by the iPod Music Quiz. In the iPod Music Quiz, the questions presented to the player are based on the music he or she has saved on his or her iPod. In particular, a portion of a song saved on the player's iPod will be played back to the individual, and he or she will have to select from a list of possible song titles which is the song that is currently being played. The faster the player selects the correct title, the more points he or she will earn. The iPod Music Quiz, however, is a one-player game. In other words, multiple players cannot compete against one another. Extended and repeated gameplay of the iPod Music Quiz is also, therefore, likely less enjoyable.

A need, therefore, exists for a music, video/movie, still image, or other media, quiz or game that provides multiple players with a variation of personalized questions that engage the players and maintain their interest for extended and repeated gameplay.

### BRIEF SUMMARY

In general, exemplary embodiments of the present invention provide an improvement by, among other things, providing a multiplayer media trivia quiz or game that generates and provides personalized questions on the fly. In particular, according to one exemplary embodiment, each time a new quiz or game commences, the media files (e.g., music, video, still images etc.) stored on each of the players' electronic devices may be analyzed in order to find out in which music, videos, and the like, each of the players is interested and/or has knowledge. This information may then be used to generate trivia questions that are more specific to the people playing the game at that moment. According to one exemplary embodiment, the information is gathered and new questions are generated each time a player commences a new game, thus taking into consideration changes in the players' tastes and media collections, as well as preventing the players from learning and possibly memorizing the questions provided.

In accordance with one aspect, a method is provided of providing a personalized multiplayer media quiz or game. In one exemplary embodiment, the method includes: (1) obtaining information relating to one or more media files stored on a respective two or more electronic devices associated with a corresponding two or more users; and (2) generating one or more questions relating to the one or more media files based at least in part on the information obtained.

In one exemplary embodiment, obtaining information relating to one or more media files stored on the electronic devices includes receiving at least part of the information from the respective devices. Obtaining the information may further include retrieving the information from a network entity configured to provide information associated with a plurality of media files, or a website operated by that network entity. In one exemplary embodiment, the information obtained may include some combination of metadata, audio fingerprint calculations and/or consumption information associated with respective media files.

According to one exemplary embodiment, the method further includes comparing the information obtained in relation to respective electronic devices, such that at least one of the questions generated is based on the comparison.

In another exemplary embodiment, the method may further include transmitting one of the questions to at least one of the electronic devices, receiving an answer from at least one of the devices, and determining whether the answers received are correct. In one exemplary embodiment, transmitting the question may involve also transmitting a link to a website relating to at least one media file with which the question relates.

In accordance with another aspect, an apparatus is provided for providing a personalized multiplayer media quiz or game. In one exemplary embodiment, the apparatus includes a processor configured to: (1) obtain information relating to one or more media files stored on a respective two or more electronic devices associated with a corresponding two or more users; and (2) generate one or more questions relating to the one or more media files based at least in part on the information obtained.

According to another aspect, an apparatus is provided for participating in a personalized multiplayer media quiz or game. In one exemplary embodiment the apparatus includes a processor configured to: (1) extract information associated with one or more media files associated with the apparatus, wherein the apparatus is associated with a user; (2) transmit the information; and; (3) receive, in response, at least one question relating to the information transmitted and to information associated with one or more media files stored on a respective one or more additional electronic devices associated with one or more additional users.

In accordance with yet another aspect, a computer program product is provided for providing a personalized multiplayer media quiz or game. The computer program product contains at least one computer-readable storage medium having computer-readable program code portions stored therein. The computer-readable program code portions of one exemplary embodiment include: (1) a first executable portion for obtaining information relating to one or more media files stored on a respective two or more electronic devices associated with a corresponding two or more users; and (2) a second executable portion for generating one or more questions relating to the one or more media files based at least in part on the information obtained.

According to another aspect, an apparatus is provided for providing a personalized multiplayer media quiz or game. In one exemplary embodiment the apparatus may include: (1) means for obtaining information relating to one or more media files stored on a respective two or more electronic devices associated with a corresponding two or more users; and (2) means for generating one or more questions relating to the one or more media files based at least in part on the information obtained.

In accordance with another aspect, a system is provided for providing a personalized multiplayer media quiz or game. In one exemplary embodiment, the system may include two or more electronic devices associated with a corresponding two or more users, each storing one or more media files, and an apparatus in communication with the electronic devices. In one exemplary embodiment, the apparatus may be configured to: (1) obtain information relating to the one or more media files stored on respective electronic devices; and (2) generate one or more questions relating to the one or more media files based at least in part on the information obtained.

### BRIEF DESCRIPTION OF THE SEVERAL VIEWS OF THE DRAWING(S)

Having thus described exemplary embodiments of the invention in general terms, reference will now be made to the accompanying drawings, which are not necessarily drawn to scale, and wherein:

FIGS. 1A-1C are block diagrams of systems that would benefit from exemplary embodiments of the present invention;

FIG. 2 is a schematic block diagram of an entity capable of operating as a media quiz provider in accordance with exemplary embodiments of the present invention;

FIG. 3 is a schematic block diagram of an electronic device capable of operating in accordance with an exemplary embodiment of the present invention; and

FIG. 4 is a flow chart illustrating the provision of a personalized multiplayer media quiz in accordance with exemplary embodiments of the present invention.

### DETAILED DESCRIPTION

Exemplary embodiments of the present invention now will be described more fully hereinafter with reference to the accompanying drawings, in which some, but not all embodiments of the inventions are shown. Indeed, exemplary embodiments of the invention may be embodied in many different forms and should not be construed as limited to the embodiments set forth herein; rather, these embodiments are provided so that this disclosure will satisfy applicable legal requirements. Like numbers refer to like elements throughout.

### Overview:

In general, exemplary embodiments of the present invention provide a method, apparatus, computer program product and system for providing a personalized multiplayer media trivia game or quiz. According to exemplary embodiments, information relating to the media files (e.g., music, video, still images etc.) stored on each of the players' electronic devices (e.g., cellular telephone, PDA, laptop, PC, etc.) may be used in order to generate a wide variety of personalized questions that can be presented to the players. The information may be gathered and the questions generated each time different players commence playing. In this way, the questions can vary over time, preventing players from getting bored with the questions asked or memorizing the questions and/or answers. In addition, the questions can more accurately reflect the media in which each of the players is currently interested.

In one exemplary embodiment, the players may be remotely located from one another. In this exemplary embodiment, a media quiz provider may communicate with each of the players' electronic devices via a communication network, such as the Internet, in order to obtain information about the media files stored on the players' devices and to transmit the questions generated to each of the players. The media quiz provider may receive answers from the various players' devices, determine which of the players was correct, and then allocate points accordingly. In one exemplary embodiment, the media quiz provider is a network entity operated by a third-party service provider. Alternatively, in another exemplary embodiment, the media quiz provider may be one of the player's devices on which the necessary software for obtaining media file information and generating questions has been installed.

In another exemplary embodiment, the players may be local, or within close proximity to one another. In this exemplary embodiment, the devices may communicate directly with one another, for example via a wireless personal area network (WPAN) using Bluetooth, or similar, technology. One of the players' devices may act as the media quiz provider by obtaining all of the information about the players' media files and generating and presenting questions to the rest of the players' devices.

### Overall System and Electronic Device:

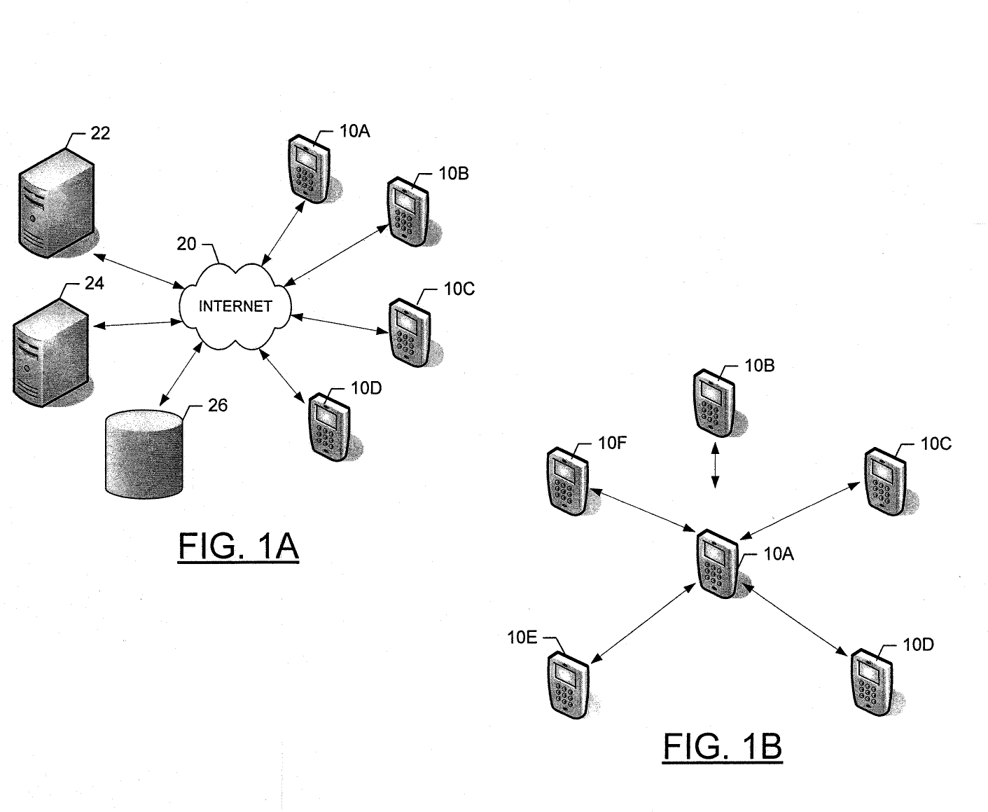

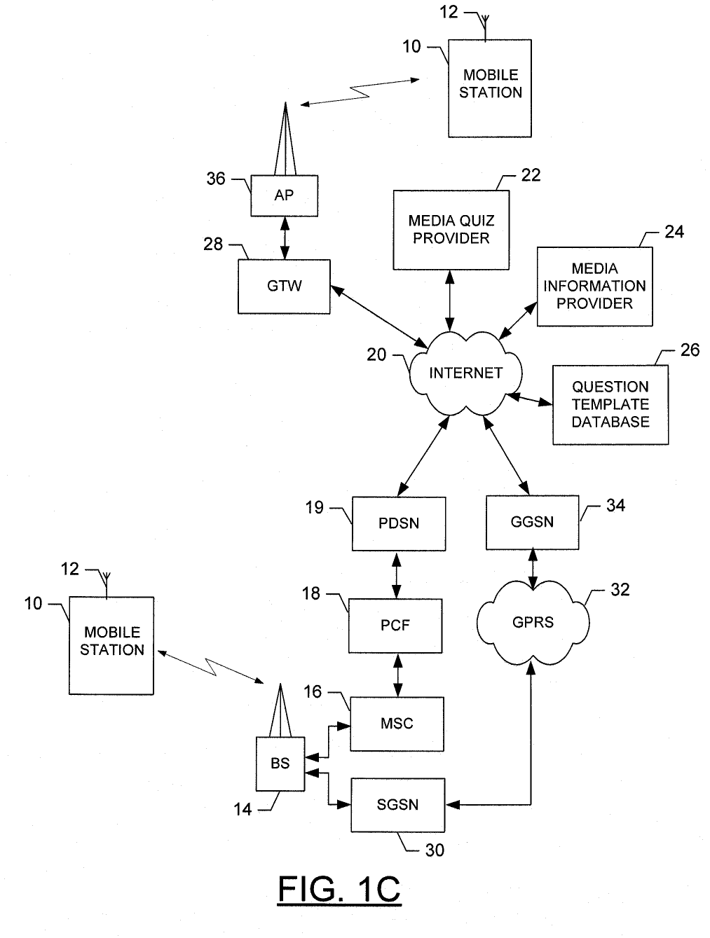

Referring to FIGS. 1A and 1B, an illustration of two types of systems that would benefit from exemplary embodiments of the present invention are provided. FIG. 1A illustrates the embodiment discussed above wherein the players are located remotely from one another, while FIG. 1B illustrates the embodiment wherein the players are located within proximity to one another.

As shown in FIG. 1A, in one exemplary embodiment in order to play the multiplayer media trivia quiz or game, two or more players may establish a connection via a communication network 20, such as the Internet, with a media quiz provider 22 using their electronic devices 10A, 10B, 10C, and 10D. While the media quiz provider 22 of FIG. 1A is shown as a server or other network entity that may be operated by a third-party service provider in order to provide the multiplayer media trivia quiz of exemplary embodiments, in an alternative embodiment, the media quiz provider 22 may be implemented by one of the players' electronic devices 10A, 10B, 10C, and 10D configured to perform the functions discussed herein (e.g., to connect to the other players' electronic devices, obtain information relating to the media files stored thereon, and generate trivia questions relating to those media files).

Once the connection has been established, the media quiz provider 22, which is discussed in more detail below, may obtain information relating to the media files saved on each of the players' devices 10A, 10B, 10C, and 10D. In particular, the media quiz provider 22 may receive the information directly from the devices 10A, 10B, 10C, and 10D, themselves. In addition, once the media quiz provider 22 has identified the media files that are stored on the devices 10A, 10B, 10C, and 10D, the media quiz provider 22 may obtain additional information relating to those files from a media information provider 24, or a network entity that is configured to provide information about a plurality of media files. For example, where the media files include songs or music files, the media information provider 24 may provide information, such as album titles, band members, touring schedules, and the like.

Once the information has been obtained, the media quiz provider 22 may generate one or more questions relating to the media files. In one exemplary embodiment, in order to do so, the media quiz provider 22 may access a question template database 26 that stores a plurality of question templates (e.g., “What is the name of the album on which this song appears?” or “Who was the director of this movie?”), from which the media quiz provider 22 may choose. While shown as a separate entity from the media quiz provider 22 that is accessible via the communication network 20, the question template database 26 may be part of or stored in memory associated with the media quiz provider 22.

In another exemplary embodiment shown in FIG. 1B, two or more players located proximate to one another (e.g., in the same room) may participate in the media trivia quiz using their electronic devices 10A, 10B, 10C, 10D, 10E, and 10F without having to access an external communication network. In particular, in this exemplary embodiment one of the electronic devices 10A may be configured to operate as the media trivia provider 22 discussed above. This electronic device 10A, and in particular a processor operating on the electronic device 10A, may be configured to establish a connection with the other electronic devices 10B, 10C, 10D, 10E, and 10F, for example over a WPAN using Bluetooth, or similar, technology, in order to receive the information relating to the media files stored on those devices. The electronic device 10A may also be configured to extract from its own memory information relating to the media files it has stored. As above, once the information is obtained, the electronic device 10A may then generate one or more questions relating to the media files stored on each of the players' electronic devices 10B, 10C, 10D, 10E, and 10F. In order to generate these questions, the electronic device 10A, and in particular a processor operating on the electronic device 10A, may access a question template database stored on the electronic device 10A itself.

While not shown, in one exemplary embodiment the system of FIG. 1B may also include an external output device in communication with the electronic device 10A that is configured to output at least a portion of the questions so that all of the players are able to see and/or hear the question. The output device may include, for example, a stereo system, a television or a similar display monitor.

Reference is now made to FIG. 1C, which provides an illustration of another type of system that would benefit from exemplary embodiments of the present invention is provided. As shown in FIG. 1C, the system can include one or more electronic devices, such as mobile stations 10, each having an antenna 12 for transmitting signals to and for receiving signals from one or more base stations (BS's) 14. The base station is a part of one or more cellular or mobile networks that each includes elements required to operate the network, such as one or more mobile switching centers (MSC) 16. As well known to those skilled in the art, the mobile network may also be referred to as a Base Station/MSC/Interworking function (BMI). In operation, the MSC is capable of routing calls, data or the like to and from mobile stations when those mobile stations are making and receiving calls, data or the like. The MSC can also provide a connection to landline trunks when mobile stations are involved in a call.

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a Packet Control Function (PCF) 18, and the PCF is coupled to a Packet Data Serving Node (PDSN) 19, which is in turn coupled to a WAN, such as the Internet 20. In turn, devices such as processing elements (e.g., personal computers, server computers or the like) can be coupled to the mobile station 10 via the Internet. For example, the processing elements can include a media quiz provider 22, a media information provider 24 and/or a question template database 26, discussed below. As will be appreciated, the processing elements can comprise any of a number of processing devices, systems or the like capable of operating in accordance with embodiments of the present invention.

The BS 14 can also be coupled to a signaling GPRS (General Packet Radio Service) support node (SGSN) 30. As known to those skilled in the art, the SGSN is typically capable of performing functions similar to the MSC 16 for packet switched services. The SGSN, like the MSC, can be coupled to a data network, such as the Internet 20. The SGSN can be directly coupled to the data network. In a more typical embodiment, however, the SGSN is coupled to a packet-switched core network, such as a GPRS core network 32. The packet-switched core network is then coupled to another GTW, such as a GTW GPRS support node (GGSN) 34, and the GGSN is coupled to the Internet.

Although not every element of every possible network is shown and described herein, it should be appreciated that the mobile station 10 may be coupled to one or more of any of a number of different networks. In this regard, mobile network(s) can be capable of supporting communication in accordance with any one or more of a number of first-generation (1G), second-generation (2G), 2.5G and/or third-generation (3G) mobile communication protocols or the like. More particularly, one or more mobile stations may be coupled to one or more networks capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. In addition, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

One or more mobile stations 10 (as well as one or more processing elements, although not shown as such in FIG. 1C) can further be coupled to one or more wireless access points (APs) 36. The AP's can be configured to communicate with the mobile station in accordance with techniques such as, for example, radio frequency (RF), Bluetooth (BT), infrared (IrDA) or any of a number of different wireless networking techniques, including Wireless LAN (WLAN) techniques. The APs may be coupled to the Internet 20. Like with the MSC 16, the AP's can be directly coupled to the Internet. In one embodiment, however, the APs are indirectly coupled to the Internet via a GTW 28. As will be appreciated, by directly or indirectly connecting the mobile stations and the processing elements (e.g., media quiz provider 22, media information provider 24 and/or question template database 26) and/or any of a number of other devices to the Internet, whether via the AP's or the mobile network(s), the mobile stations and processing elements can communicate with one another to thereby carry out various functions of the respective entities, such as to transmit and/or receive data, content or the like. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 1C, in addition to or in lieu of coupling the mobile stations 10 to one or more processing elements (e.g., media quiz provider 22, media information provider 24 and/or question template database 26) across the Internet 20, one or more such entities may be directly coupled to one another. As such, one or more network entities may communicate with one another in accordance with, for example, RF, BT, IrDA or any of a number of different wireline or wireless communication techniques, including LAN and/or Wireless LAN techniques. Further, the mobile station 10 and the processing elements can be coupled to one or more electronic devices, such as printers, digital projectors and/or other multimedia capturing, producing and/or storing devices (e.g., other terminals).

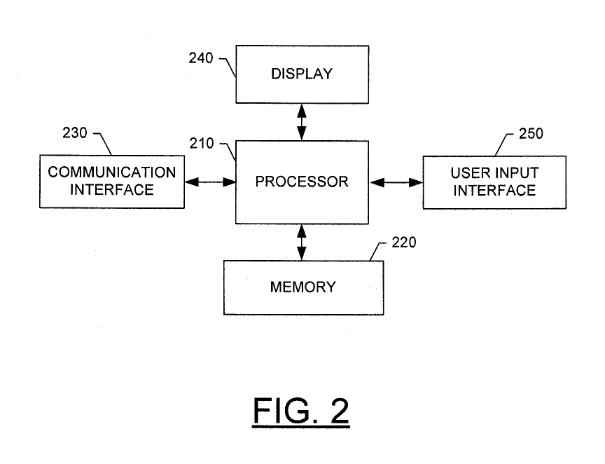

Referring now to FIG. 2, a block diagram of an entity capable of operating as a media quiz provider 22 is shown in accordance with one embodiment of the present invention. The entity capable of operating as a media quiz provider 22 includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. As shown, the entity capable of operating as a media quiz provider 22 can generally include means, such as a processor 210 for performing or controlling the various functions of the entity. In one embodiment, the processor is in communication with or includes memory 220, such as volatile and/or non-volatile memory that stores content, data or the like. For example, the memory 220 typically stores content transmitted from, and/or received by, the entity. Also for example, the memory 220 typically stores software applications, instructions or the like for the processor to perform steps associated with operation of the entity in accordance with embodiments of the present invention. In one exemplary embodiment, the memory 220 may store software instructions for obtaining information relating to one or more media files stored on a respective two or more electronic devices operated by media quiz or game players, and generating one or more questions relating to the media files based at least in part on the information obtained.

In addition to the memory 220, the processor 210 can also be connected to at least one interface or other means for displaying, transmitting and/or receiving data, content or the like. In this regard, the interface(s) can include at least one communication interface 230 or other means for transmitting and/or receiving data, content or the like, as well as at least one user interface that can include a display 240 and/or a user input interface 250. The user input interface, in turn, can comprise any of a number of devices allowing the entity to receive data from a user, such as a keypad, a touch display, a joystick or other input device.

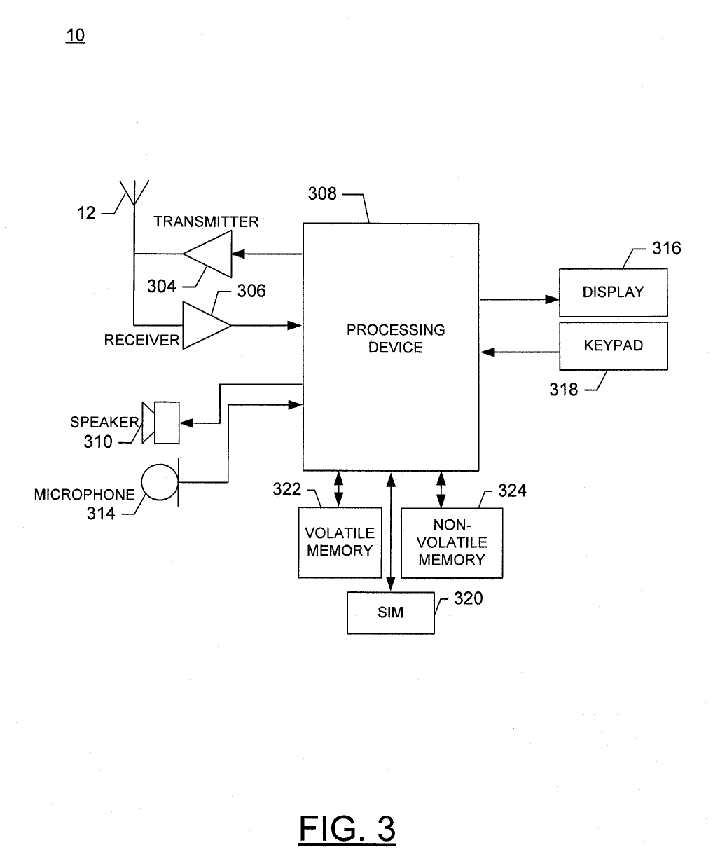

Reference is now made to FIG. 3, which illustrates one type of electronic device that would benefit from embodiments of the present invention. As shown, the electronic device may be a mobile station 10, and, in particular, a cellular telephone. It should be understood, however, that the mobile station illustrated and hereinafter described is merely illustrative of one type of electronic device that would benefit from the present invention and, therefore, should not be taken to limit the scope of the present invention. While several embodiments of the mobile station 10 are illustrated and will be hereinafter described for purposes of example, other types of mobile stations, such as personal digital assistants (PDAs), pagers, laptop computers, as well as other types of electronic systems including both mobile, wireless devices and fixed, wireline devices, can readily employ embodiments of the present invention.

The mobile station includes various means for performing one or more functions in accordance with exemplary embodiments of the present invention, including those more particularly shown and described herein. It should be understood, however, that the mobile station may include alternative means for performing one or more like functions, without departing from the spirit and scope of the present invention. More particularly, for example, as shown in FIG. 3, in addition to an antenna 302, the mobile station 10 includes a transmitter 304, a receiver 306, and means, such as a processing device 308, e.g., a processor, controller or the like, that provides signals to and receives signals from the transmitter 304 and receiver 306, respectively. These signals include signaling information in accordance with the air interface standard of the applicable cellular system and also user speech and/or user generated data. In this regard, the mobile station can be capable of operating with one or more air interface standards, communication protocols, modulation types, and access types. More particularly, the mobile station can be capable of operating in accordance with any of a number of second-generation (2G), 2.5G and/or third-generation (3G) communication protocols or the like. Further, for example, the mobile station can be capable of operating in accordance with any of a number of different wireless networking techniques, including Bluetooth, IEEE 802.11 WLAN (or Wi-Fi®), IEEE 802.16 WiMAX, ultra wideband (UWB), and the like.

It is understood that the processing device 308, such as a processor, controller or other computing device, may include the circuitry required for implementing the video, audio, and logic functions of the mobile station and may be capable of executing application programs for implementing the functionality discussed herein. For example, the processing device may be comprised of various means including a digital signal processor device, a microprocessor device, and various analog to digital converters, digital to analog converters, and other support circuits. The control and signal processing functions of the mobile device are allocated between these devices according to their respective capabilities. The processing device 308 thus also includes the functionality to convolutionally encode and interleave message and data prior to modulation and transmission. The processing device can additionally include an internal voice coder (VC) 308A, and may include an internal data modem (DM) 308B. Further, the processing device 308 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile station may also comprise means such as a user interface including, for example, a conventional earphone or speaker 310, a ringer 312, a microphone 314, a display 316, all of which are coupled to the controller 308. The user input interface, which allows the mobile device to receive data, can comprise any of a number of devices allowing the mobile device to receive data, such as a keypad 318, a touch display (not shown), a microphone 314, or other input device. In embodiments including a keypad, the keypad can include the conventional numeric (0-9) and related keys (#, *), and other keys used for operating the mobile station and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile station can also include means, such as memory including, for example, a subscriber identity module (SIM) 320, a removable user identity module (R-UIM) (not shown), or the like, which typically stores information elements related to a mobile subscriber. In addition to the SIM, the mobile device can include other memory. In this regard, the mobile station can include volatile memory 322, as well as other non-volatile memory 324, which can be embedded and/or may be removable. For example, the other non-volatile memory may be embedded or removable multimedia memory cards (MMCs), secure digital (SD) memory cards, Memory Sticks, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. For example, the memory may store one or more media files, such as music files, video files (e.g., representing movies and/or television shows), still images, and the like. As another example, the memory may store computer program code for an application and other computer programs. For example, in one embodiment of the present invention, the memory may store computer program code for extracting information associated with one or more media files stored on the mobile station, transmitting the extracted information, for example, to the media quiz provider 22 discussed above, and receiving, in response, at least one question relating to the information transmitted and to information associated with one or more media files stored on a respective one or more additional mobile stations operated by the other players of the media quiz. Alternatively, or in addition, in the embodiment discussed above wherein the mobile station operates as the media quiz provider 22, the memory may store computer program code for obtaining information relating to media files stored on the other players' devices and generating questions relating to those media files.

The method, apparatus, computer program product and system of exemplary embodiments of the present invention are primarily described in conjunction with mobile communications applications. It should be understood, however, that the method, apparatus, computer program product and system of embodiments of the present invention can be utilized in conjunction with a variety of other applications, both in the mobile communications industries and outside of the mobile communications industries. For example, the method, apparatus, computer program product and system of exemplary embodiments of the present invention can be utilized in conjunction with wireline and/or wireless network (e.g., Internet) applications.

### Method of Providing a Personalized Multiplayer Media Quiz

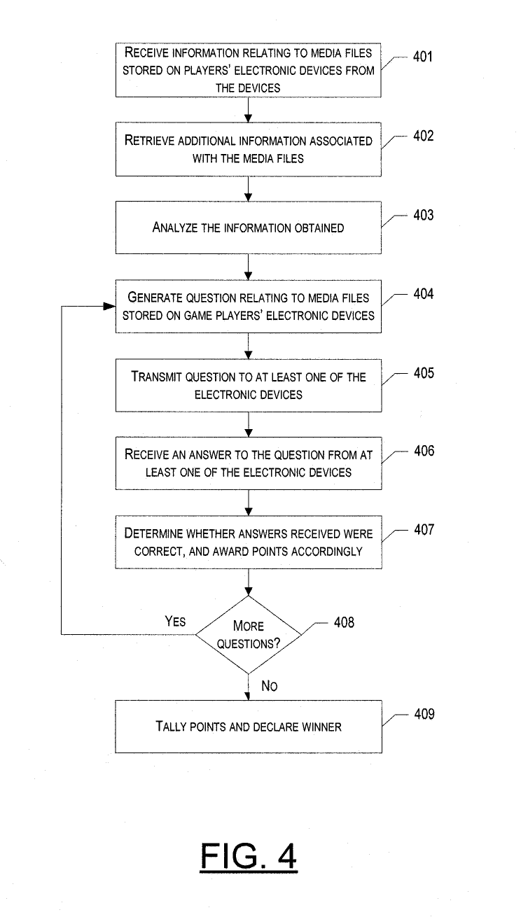

Referring now to FIG. 4, the operations are illustrated that may be taken in order to provide a personalized multiplayer media quiz or game in accordance with exemplary embodiments of the present invention. As shown, the process may begin at Block 401 when the entity acting as the media quiz provider (e.g., a network entity or an electronic device operated by one of the players), and in particular, a processor operating on the media quiz provider, receives information relating to the media files stored on each of the players' electronic devices. While not shown, prior to this, one of the players may first initiate game play with the other players by, for example, transmitting an SMS (Short Message Service), or similar, message to the electronic devices of the other players and asking them to join in the media quiz, or using Session Initiation Protocol (SIP). Alternatively, in another exemplary embodiment, one player may simply establish a connection via his or her electronic device with the media quiz provider and then request that additional, players be contacted by the media quiz provider. The additional players may, for example, be randomly selected. Alternatively, the media quiz provider may suggest specific individuals deemed suitable gaming partners based, for example, on similarities in artists and/or genres represented in the individuals' collections (e.g., maximizing the number of artists and/or genres the players have in common), or any other known factors used to match individuals' music or other media profiles. In another exemplary embodiment, the user may be able to view games that are ongoing throughout the world and then select which game he or she would like to join (i.e., with which players he or she would like to initiate game play). In this exemplary embodiment, details of the ongoing games (e.g., a summary of the media files and/or preferences of the players) may be displayed in order to assist the user in selecting which game to join. In yet another exemplary embodiment, there may be multiple media quiz providers from which the user may select based on his or her preferences. Regardless of the method used to initiate game play, once one or more players have agreed to play with the soliciting party, the players may then connect, via their electronic devices, to the media quiz provider to initiate game play.

In order to receive the information relating to the media files stored on respective game players' devices, in one exemplary embodiment respective electronic devices, and in particular a processor operating on the electronic device, may be configured to browse through the media files (e.g., music files, videos, still images, etc.) stored on the electronic device and extract information associated with those media files, such as metadata, ID3 tags, file names, and the like. As one of ordinary skill in the art will recognize, ID3 tags are often associated with MP3 audio files and are used to store information such as title, artist, album, track number and various musical parameters such as musical genre. The electronic device may further be configured to collect audio fingerprint calculations that can be used to identify and/or categorize music files stored on the electronic devices. The information extracted and collected may then be transmitted to the media quiz provider, which receives it at Block 401.

The media quiz provider may then, at Block 402, retrieve additional information associated with the media files stored on each player's electronic device. In one exemplary embodiment, the media quiz provider may retrieve this additional information by accessing a network entity configured to provide information associated with a plurality of media files (e.g., the media information provider 24 discussed above), or a website operated by that network entity. For example, the media quiz provider may access the All Music Guide (AMG) via the website www.allmusic.com. AMG, which is owned by All Media Guide, is a metadata database about music. Information that may be retrieved from AMG may include, for example, song names, genre, credits, copyright information, product numbers, styles, tones, moods, themes, nationalities, similar artists and albums, influences, biographies, reviews, rating, and the like.

In one exemplary embodiment, the additional information may include media consumption information associated with each media file. For example, the media quiz provider may retrieve information, such as playlists created by respective players and/or the playcounts of different songs or videos during, for example, the most recent weeks or months. In one exemplary embodiment, this information may have been collected by the electronic device, and in particular a processor operating on the electronic device, such that the collected information can be transmitted directly from the electronic device to the media quiz provider. Alternatively, a music service, such as last.fm (www.last.fm) may have separately collected this information for the player, in which case the media quiz provider may retrieve the consumption information from the music service.

In one exemplary embodiment, prior to retrieving additional information, the media quiz provider may need to take some additional steps in order to identify the media files for which additional information is desired. In particular, in one exemplary embodiment only audio fingerprint calculations may be received from the electronic devices at Block 401. In this exemplary embodiment, the media quiz provider may first need to identify the media file using, for example, song recognition software such as AudioID offered by M2any (See www.m2any.com/basics.htm). Once the media file has been identified, the media quiz provider may then retrieve essentially all information associated with the media file (i.e., not having received any information from the electronic device).

In one exemplary embodiment, not shown, the information received at Block 401 and/or retrieved at Block 402 may be saved by the media quiz provider and in some manner associated with the player on whose device the corresponding media files are stored. In this exemplary embodiment, the media quiz provider may determine what information is already stored in relation to a player and his or her electronic device prior to obtaining any additional information, and then only obtain information relating to new media files that have been stored to the player's device.

Once a sufficient amount of information has been obtained, the media quiz provider, and in particular a processor operating on the media quiz provider may, at Block 403, analyze the information obtained. In one exemplary embodiment, this may include comparing the information obtained for each of the players and determining if there are any similarities or commonalities in bands, music or movie genres, actors, and the like. It may also involve determining whether there are any media files, or attributes associated with those media files, that are unique to a particular player. As one of ordinary skill in the art will recognize, there are any number of ways to analyze the information obtained relating to media files stored on the players' electronic devices, all of which fall within the spirit and scope of exemplary embodiments of the invention.

Based on the information obtained and the analysis performed, a question may then be generated, at Block 404, that relates to one or more media files stored on one or more of the game players' electronic devices. As noted above, in order to generate the question, the media quiz provider may access a question template database stored on or separate from the media quiz provider. Examples of questions that may be generated may include “What song is this?”; “What movie/television series/video is this?”; “What picture/comic is this?”; “What is the name of the drummer in this band?”; “What year was this album produced?”; “How many albums does this band have?”; “From what country is this band from?”; “Where was this movie shot?”; “Who was the director of this movie?”; “What time of the year was this picture taken?”; “Where was this picture taken?”; and the like.

In one exemplary embodiment, one or more of the questions may be based on a categorization of the data collected (e.g., “What is the band that everyone listens to except Guy?”). Alternatively, or in addition, one or more of the questions may be based on personalized tags associated with the media files by one or more of the players (e.g., “Which player ‘loves’ this song?”). Similarly, one or more questions may be based on community-generated personalized tags (e.g., “What is the most common comment people have about this song?”), wherein the media quiz provider may store personalized tags associated with various media files and compare them. In one exemplary embodiment, the level of complexity or difficulty of the question may be pre-selected by the players. Alternatively, the level may change as the game progresses depending upon how easily the players are able to answer the questions posed (e.g., how quickly and/or how accurately).

At Block 405, the question generated may be transmitted by the media quiz provider to at least one of the electronic devices operated by the game players. In one exemplary embodiment, transmitting the question to one or all of the electronic devices may include streaming at least a portion of the media file (e.g., song, video, still image, etc.) associated with the question to respective devices. In particular, a question may include an audio or video clip of a song or movie, along with a text or voice message that includes the question relating to the audio or video clip (e.g., “In what country was this movie filmed?”). In one exemplary embodiment, the portion of the media file may be streamed directly from the media quiz provider, or a database associated with the media quiz provider, to the electronic devices. Alternatively, the media file, or portion thereof, may be streamed from one player's device to the other player's devices.

In one exemplary embodiment wherein the question includes playing a portion of a song, the media quiz provider may first extract the chorus section of the song, which may be more easily recognized by the players. In particular, the media quiz provider may use, for example, technology described in U.S. application Ser. No. 11/692,821, entitled “System and Method for Music Data Repetition Functionality,” filed Mar. 28, 2007, the contents of which are hereby incorporated herein by reference in their entirety, to perform the chorus extraction.

In the exemplary embodiment discussed above wherein the players are together (i.e., local or within proximity of one another), the media quiz provider may transmit the question to only one of the electronic devices (referred to as the “gamemaster” device). The gamemaster device may then display, or otherwise output, the question to the other players using, for example, a home stereo, television, or other similar display monitor. Alternatively, in the exemplary embodiment discussed above wherein the players and their devices are located remotely from one another, the question may be transmitted to each of the electronic devices separately.

In one exemplary embodiment, each round of play may have a primary player responsible for performing some task in relation to a media file. For example, the media quiz provider may stream a video clip of a movie or television show to the electronic device operated by the primary player only. The primary player may then be required to act out the clip in front of a camera or similar video capture device operating on the primary player's electronic device (e.g., the EyeToy discussed above). The camera may then record the performance and transmit it to the other players' devices. The other players may then have to guess what the movie or television show is, or who is the actor the primary player is mimicking. Similarly, as another example, the media quiz provider may transmit the title or short clip of a song to the primary player, who must then perform the song, again in front of the camera and microphone, so that the other players can answer some question relating to the song performed.

In one exemplary embodiment, transmitting the question may include transmitting possible answers to the question, from which the players may select. In another exemplary embodiment, not shown, the media quiz provider may also generate and transmit one or more tips for answering the questions. For example, where the question is to name a song or movie, one tip may be based on statistic information associated with the song or movie (e.g., “All players have music from this artist in their electronic device,” or “This song is from a genre that Andy never listens to”), consumption information associated with the song or movie (e.g., “Cory has listened to this song several times in the last two weeks”) and/or metadata associated with the song or movie (e.g., “This song was made in the 70's”). In one exemplary embodiment, the tip may be transmitted to the players' electronic devices after a certain amount of time has passed and no answers to the question have been received by the media quiz provider.

In yet another exemplary embodiment, the media quiz provider may also transmit to the electronic devices a link to a website that is associated with the media file with which the question relates. For example, the link may be to a website operated by the music provider from which the players can purchase the song that is the subject of the question. The link may likewise be to a website that provides information about the song, video or still image. For example, if the question relates to an image of Paris, the link may be to a website operated by a travel agent who specializes in Parisian rendezvous.

Returning to FIG. 4, at Block 406, the media quiz provider may receive an answer to the question posed from one or more of the players' electronic devices. As discussed above, in one exemplary embodiment one or more choices of answers may be presented to the players, in which case, the media quiz provider may receive a selection of the choices provided. The media quiz provider, and in particular a processor operating on the media quiz provider, may then determine whether the answers received were correct and award points accordingly. (Block 407). In one exemplary embodiment, the number of points awarded may depend, for example, upon the difficulty of the question and/or the amount of time it took to answer (e.g., the number of points awarded may decrease as time goes by).

It may then be determined, at Block 408, whether the players would like to continue playing. If so, the process returns to Block 404 where another question is generated based on the information obtained and analyzed. As noted above, in one exemplary embodiment, the difficulty of the question, and any subsequent questions, may depend upon how quickly the players answered the previous question and/or how many of the players got it right.

If it is determined, at Block 408, that the players do not wish to receive anymore questions, the process may continue to Block 409 where the media quiz provider tallies the points of each player and declares a winner. In one exemplary embodiment, the winner may receive some sort of award or prize relating to media files. For example, the winner may receive one free download from a music provider. Alternatively, or in addition, the winner may receive some or all of the media files of the other players. In particular, in one exemplary embodiment, each player may select which portion of his or her media collection he or she wishes to “put into the game.” The questions may then be generated based only on these media files. At the end of the game, or at least at the end of a round of the game, the winner may receive all of the media files put into the game at that point, while the losers may lose those media. This could be repeated for several rounds of gameplay, wherein each player puts media files into the game at the beginning of each round.

In another exemplary embodiment, media files may be used similar to poker chips in a game of poker, wherein players place wagers on each round (e.g., each question) by putting media files into the game. For example, a player may place several media files into the game if he or she is confident in his or her ability to answer a question. The other players may then be required to call the bet by placing the same number of media files into the game, raise the bet by putting even more media files into the game, or give up and lose the media files currently under play. Players may assess the risk/reward of continuing gameplay at each round by viewing a summary of the media files that have been put into the game thus far. The more familiar the media files put into the game, the more confident the player may be that he or she will be able to answer the questions. Correspondingly, the player may assess the potential reward by looking at how interested he or she is in the media files currently under play. This exemplary embodiment may provide an entertaining way of getting rid of the media files an individual no longer enjoys and obtaining new media files from individuals with similar tastes and interests. In this exemplary embodiment, the media quiz provider may also provide poker table-like visualizations of the currently ongoing games, enabling a potential player to view the media files under play in the various games and decide which game to join (e.g., which game the player feels has the more interesting media files worth obtaining).

Based on the foregoing, exemplary embodiments of the present invention provide a music, video/movie, still image, or other media, quiz or game that provides multiple players with a variation of personalized questions that engage the players and maintain their interest for extended and repeated gameplay.

### CONCLUSION

As described above and as will be appreciated by one skilled in the art, embodiments of the present invention may be configured as a method, apparatus and system. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Exemplary embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these exemplary embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
obtaining information relating to one or more media files stored on a respective two or more electronic devices associated with a corresponding two or more users; and
generating one or more questions relating to the one or more media files based at least in part on the information obtained.

2. The method of claim 1, wherein obtaining information relating to one or more media files comprises receiving at least part of the information from the respective electronic devices.

3. The method of claim 2, wherein obtaining information relating to one or more media files further comprises retrieving at least part of the information from a network entity configured to provide information associated with a plurality of media files or a website operated by the network entity.

4. The method of claim 1, wherein the information comprises some combination of metadata associated with respective media files, audio fingerprint calculations associated with respective media files, and consumption information associated with respective media files.

5. The method of claim 1 further comprising:
comparing the information obtained in relation to respective electronic devices, wherein generating one or more questions relating to the one or more media files comprises generating at least one question based on the comparison.

6. The method of claim 1 further comprising:
transmitting one of the one or more questions to at least one of the two or more electronic devices;
receiving an answer to the question transmitted from at least one of the two or more electronic devices; and
determining whether respective answers received are correct.

7. The method of claim 6, wherein transmitting one of the one or more questions further comprises transmitting a link to a website relating to at least one media file with which the question relates.

8. An apparatus comprising:
a processor configured to:
obtain information relating to one or more media files stored on a respective two or more electronic devices associated with a corresponding two or more users; and
generate one or more questions relating to the one or more media files based at least in part on the information obtained.

9. The apparatus of claim 8, wherein in order to obtain information relating to one or more media files, the processor is further configured to receive at least part of the information from the respective electronic devices.

10. The apparatus of claim 9, wherein in order to obtain information relating to one or more media files, the processor is further configured to retrieve at least part of the information from a network entity configured to provide information associated with a plurality of media files or a website operated by the network entity.

11. The apparatus of claim 8, wherein the information comprises some combination of metadata associated with respective media files, audio fingerprint calculations associated with respective media files, and consumption information associated with respective media files.

12. The apparatus of claim 8, wherein the processor is further configured to compare the information obtained in relation to respective electronic devices, and wherein in order to generate one or more questions relating to the one or more media files, the processor is further configured to generate at least one question based on the comparison.

13. The apparatus of claim 8, wherein the processor is further configured to:
transmit one of the one or more questions to at least one of the two or more electronic devices;
receive an answer to the question transmitted from at least one of the two or more electronic devices; and
determine whether respective answers received are correct.

14. The apparatus of claim 8, wherein the apparatus comprises one of the two or more electronic devices, and wherein in order to obtain the information relating to one or more media files the processor is further configured to extract at least part of the information from a memory operated on the apparatus.

15. The apparatus of claim 14, wherein the processor is further configured to:
display one of the one or more questions generated; and
receive an answer to the question displayed.

16. The apparatus of claim 15, wherein in order to display the question generated, the processor is further configured to display at least part of a media file with which the question relates.

17. An apparatus comprising:
a processor configured to:
extract information associated with one or more media files associated with the apparatus, said apparatus associated with a user;
transmit the information; and
receive, in response, at least one question relating to the information transmitted and to information associated with one or more media files stored on a respective one or more additional electronic devices associated with one or more additional users.

18. The apparatus of claim 17 further comprising:
a display device configured to display the at least one question; and
an input device configured to receive an answer to the at least one question displayed.

19. The apparatus of claim 18, wherein in order to display the question generated, the display device is further configured to display at least part of a media file with which the question relates.

20. A computer program product comprising at least one computer-readable storage medium having computer-readable program code portions stored therein, said computer-readable program code portions comprising:
a first executable portion for obtaining information relating to one or more media files stored on a respective two or more electronic devices associated with a corresponding two or more users; and
a second executable portion for generating one or more questions relating to the one or more media files based at least in part on the information obtained.

21. The computer program product of claim 20, wherein the first executable portion is configured to receive at least part of the information from the respective electronic devices.

22. The computer program product of claim 21, wherein the first executable portion is further configured to retrieve at least part of the information from a network entity configured to provide information associated with a plurality of media files or a website operated by the network entity.

23. The computer program product of claim 20, wherein the information comprises some combination of metadata associated with respective media files, audio fingerprint calculations associated with respective media files, and consumption information associated with respective media files.

24. The computer program product of claim 20, wherein the computer-readable program code portions further comprise:
a third executable portion for comparing the information obtained in relation to respective electronic devices, wherein the second executable portion is configured to generate at least one question based on the comparison.

25. The computer program product of claim 20, wherein the computer-readable program code portions further comprise:
a third executable portion for transmitting one of the one or more questions to at least one of the two or more electronic devices;
a fourth executable portion for receiving an answer to the question transmitted from at least one of the two or more electronic devices; and
a fifth executable portion for determining whether respective answers received are correct.

26. An apparatus comprising:
means for obtaining information relating to one or more media files stored on a respective two or more electronic devices associated with a corresponding two or more users; and
means for generating one or more questions relating to the one or more media files based at least in part on the information obtained.

27. The apparatus of claim 26, wherein the means for obtaining information relating to one or more media files comprises a means for receiving at least part of the information from the respective electronic devices and a means for retrieving at least part of the information from a network entity configured to provide information associated with a plurality of media files or a website operated by the network entity.

28. The apparatus of claim 26 further comprising:
means for transmitting one of the one or more questions to at least one of the two or more electronic devices;
means for receiving an answer to the question transmitted from at least one of the two or more electronic devices; and
means for determining whether respective answers received are correct.

29. A system comprising:
two or more electronic devices associated with a corresponding two or more users, respective electronic devices storing one or more media files;
an apparatus in communication with the electronic devices, said apparatus configured to obtain information relating to the one or more media files stored on respective electronic devices; and
generate one or more questions relating to the one or more media files based at least in part on the information obtained.

30. The system of claim 29, wherein in order to obtain information relating to the one or more media files, the apparatus is further configured to receive at least part of the information from respective electronic devices.

31. The system of claim 30 further comprising:
a network entity configured to provide information associated with a plurality of media files, wherein in order to obtain information relating to the one or more media files, the apparatus is further configured to retrieve at least part of the information from the network entity or a website operated by the network entity.

32. The system of claim 29, wherein the information comprises some combination of metadata associated with respective media files, audio fingerprint calculations associated with respective media files, and consumption information associated with respective media files.

33. The system of claim 29, wherein the apparatus is further configured to:
transmit one of the one or more questions to at least one of the two or more electronic devices;
receive an answer to the question transmitted from at least one of the two or more electronic devices; and
determine whether respective answers received are correct.

34. The system of claim 29, wherein the apparatus is further configured to:
display one of the one or more questions generated; and
receive an answer to the question displayed.

35. The system of claim 34, wherein in order to display the question generated, the apparatus further configured to display at least part of a media file with which the question relates.

36. The system of claim 35 further comprising:
a display device, wherein in order to display the question generated and at least part of the media file with which the question relates, the apparatus is further configured to transmit the question generated and at least part of the media file to the display device.
